(19) United States
(12) Patent Application Publication
(10) Pub. No.: US 2003/0210272 A1
(43) Pub. Date: Nov. 13, 2003

(54) System and method for providing a user interface

(75) Inventor: Melroy E. D'Souza, Rancho Santa Margarita, CA (US)

Correspondence Address: GATEWAY, INC., ATTENTION: IP LAW GROUP (MAIL STOP SD-21), 14303 GATEWAY PLACE, POWAY, CA, 92064, US

(73) Assignee: Gateway, Inc.

(21) Appl. No.: 10/142,234

(22) Filed: May 9, 2002

(51) Int. Cl. G09G 5/00

(52) U.S. Cl. 345/773

(57) ABSTRACT

The present invention is directed to a system and method of providing a user interface displayable by a display device of an information handling system including a display of an input device which does not interfere with data displayed on the display data and which is accessible to the user.

### FIELD OF THE INVENTION

The present invention generally relates to the field of displays of information, and particularly to a system and method for providing a user interface.

### BACKGROUND OF THE INVENTION

Information handling systems, and the role the systems play in everyday life, is becoming ever more prevalent. Because of the increased use of information handling systems, it is now necessity in many aspects of business and the like to be able to interact with the system in an efficient and intuitive manner.

One of the many advantages of information handling systems is the ability to provide access to functionality to users where previously such access was difficult if not impossible to realize. For instance, information handling systems may provide programs and communications to enable people with disabilities to communicate in an improved manner. Motion tracking devices, for example, may be utilized to enable a user to enter data into an information handling system, such as through use of an IR tracking motion device to enable a user to interact with a display of an input device on a display device. However, the display of the device may become covered by pop-up windows, overridden with dialogue boxes, and the like. This may force a user of the input device to navigate through a multitude of windows just to return to the input device, thereby result in great frustration to the user, as well as lost productivity.

Therefore, it would be desirable to provide a system and method for providing a user-interface displayable by a display device which is accessible by a user and may be utilized to manipulate data without being interfered with.

### SUMMARY OF THE INVENTION

Accordingly, the present invention is directed to a system and method of providing a user interface displayable by a display device of an information handling system including a display of an input device which does not interfere with data displayed on the display data and which is accessible to the user. In an aspect of the present invention, a method of providing a dividable user-interface which is displayable by a display device of an information handling system including outputting a user interface having an initial display of information by a display device of an information handling system. The user interface is divided into at least a first portion having data corresponding to the initial display of information and a second portion having a display of an input device. The input device is suitable for providing data entered by a user through the input device to the information handling system. In which, the display of the input device displayed in the second portion of the user interface does not substantially interfere with data corresponding to the initial display of information as displayed in the first portion of the user interface.

In an additional aspect of the present invention, an information handling system including a dividable user-interface, includes a memory suitable for storing a program of instructions, a display device suitable for providing a display of data, and a processor suitable for performing a program of instructions. The processor is communicatively coupled to the display device and the memory. The program of instructions configures the processor to output a user interface having an initial display of information by the display device. The user interface is divided into at least a first portion having data corresponding to the initial display of information and a second portion having a display of an input device. The display of the input device displayed in the second portion of the user interface does not substantially interfere with data corresponding to the initial display of information as displayed in the first portion of the user interface.

In a further aspect of the present invention, a dividable user-interface displayable by a display device of an information handling system includes a user interface divided from an initial display of information output by a display device of an information handling system. The divided user interface includes at least a first portion having data corresponding to the initial display of information and a second portion having a display of an input device. The display of the input device is suitable for providing data entered by a user through the input device to the information handling system. The display of the input device displayed in the second portion of the user interface does not substantially interfere with data corresponding to the initial display of information as displayed in the first portion of the user interface.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration a prior art display of a keyboard interfering with a display of information;

FIG. 2A is an illustration of an embodiment of the present invention wherein a display of an input device configured as a keyboard is employed to enable a user to interact with an initial display of data is shown;

FIG. 2B is an illustration of an embodiment of the present invention wherein a user interface including a first portion having a display of data received from a user application and a second portion having a display of an input device arranged in a vertical manner is shown;

FIG. 3A is a flow chart depicting an exemplary method of the present invention wherein an output of an initial display of information is divided into at least a first portion including the initial display of information and a second portion having a display of an input device;

FIG. 3B is a flow chart of an exemplary method of the present invention wherein a request is received from a user to divide a user interface to include a display of an input device which is suitable for providing data to a program of instructions supplying the displayed data;

FIG. 4 is an illustration of an embodiment of the present invention wherein an initial display of data output by a display device is arranged so that a display of an input device does not interfere with the initially displayed data;

FIG. 5 is an illustration of an embodiment of the present invention wherein a display of an input device output by a display device is arranged so that it does not interfere with data corresponding to an initial display of data;

FIG. 6 is an illustration of an embodiment of the present invention wherein a priority is assigned to displayable elements to be utilized in determining the presentational aspects of a window; and

FIG. 7 is a flow chart depicting an exemplary method of the present invention wherein a user interface providing a display of an input device is optimized.

### DETAILED DESCRIPTION OF THE INVENTION

Reference will now be made in detail to the presently preferred embodiments of the invention, examples of which are illustrated in the accompanying drawings.

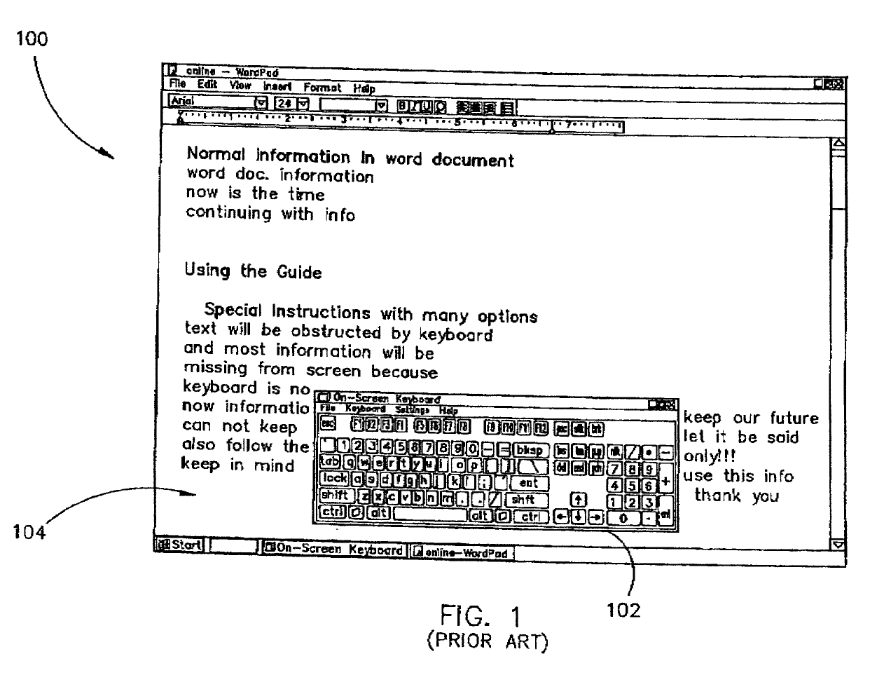

Referring generally now to FIGS. 1 through 7, embodiments of the present invention are shown. Information handling systems, such as desktop computers, personal digital assistants, digital information appliances, internet appliances, convergence system and the like, provide the ability to access functionality where previously such access was difficult to realize. To promote this increased ability of information handling systems, a variety of legislation has been proposed and passed to encourage such access, such as Section 508 of the Rehabilitation Act which addresses access to information in electronic form for people with disabilities in purchasing decisions by Federal Agencies.

Access to information handling systems may be provided in a variety of ways. For example, a motion tracking device may be utilized to enable a user to enter data through use of a wearable IR motion tracking device utilized in conjunction with a display of data so that the user may interact with an information handling system. However, the display of the device may become covered by pop-up windows, overridden by dialogue boxes, and the like. This may force a user of the input device to navigate through a multitude of windows just to return to the input device, thereby result in great frustration to the user, as well as lost productivity.

Additionally, the display of the input device may interfere with an initial display of data. For example, as shown in the prior art example 100 depicted in FIG. 1, previously, when a display of an input device was provided, such as a keyboard 102, the keyboard 102 interfered with an initial display of data 104, such as data provided from a program operating on an information handling system. Thus, a user of the information handling system was unable to interact with data displayed “behind”, i.e. covered, by the display of the keyboard 102. A user wishing to interact with such a display of data was forced to scroll the initial display of data, manually reposition the keyboard 102, and the like. Such manipulation resulted in great inefficiencies and was often frustrating to users of the system.

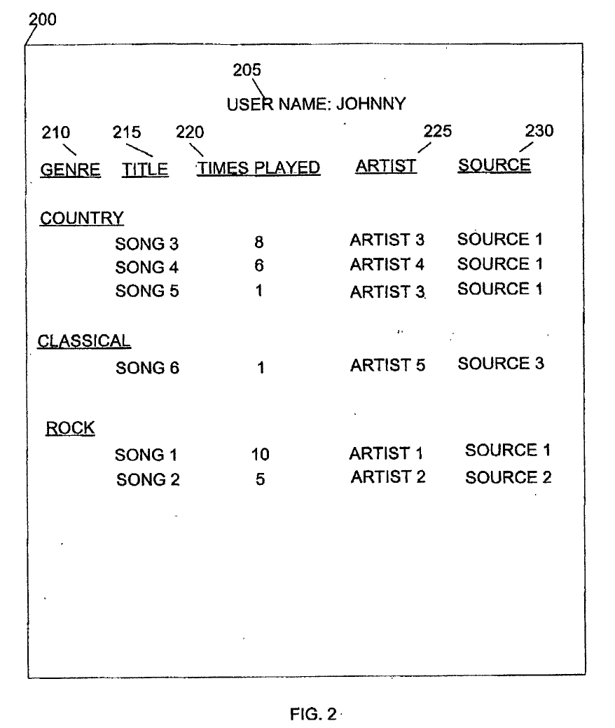

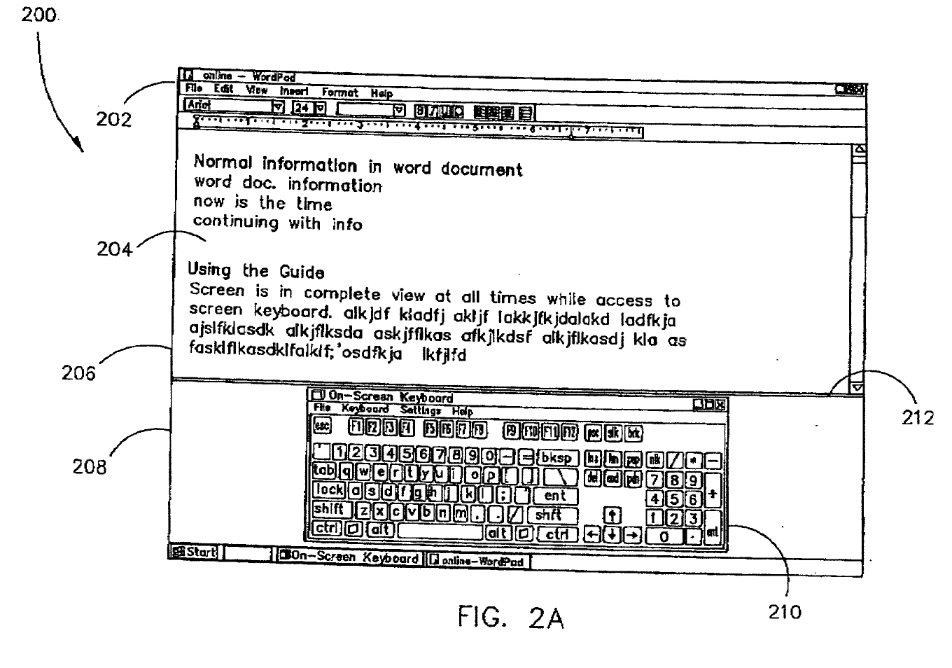

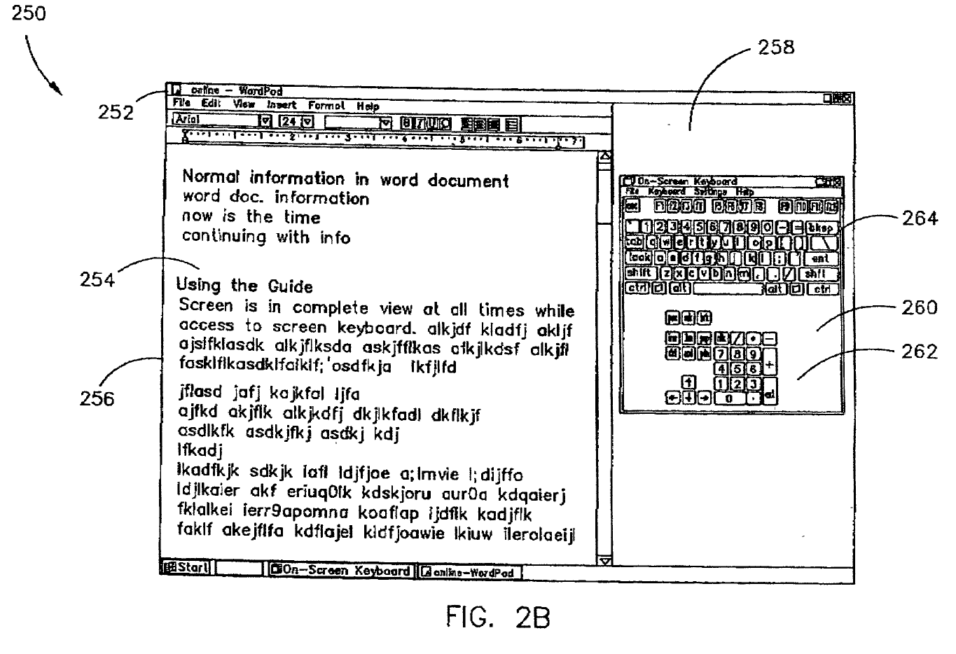

In the present invention, a display of an input device on a display device is provided so that the display of the input user interface does not interfere with initially displayed data. For example, as shown in the embodiment 200 of the present invention depicted in FIG. 2A, a display of an input device configured as a keyboard is employed to enable a user to interact with an initial display of data. A user interface 202 includes a display of data 204, in this instance a document provided by a word processor, in a first portion 206 of the user interface 202. The display of data 204 includes data obtained from an initial display of data provided in an undivided screen.

The user interface 202 also includes a second portion 208 of the display of data including a display of an input device configured as a keyboard 210. The keyboard 210 is displayed in a QWERTY format, although other data entry formats are contemplated by the present invention without departing from the spirit and scope therefore, such as alphabetical, numerical, and the like. The keyboard 210 display in the second portion 208 of the user interface may be utilized to enter data to manipulate the display of data in the first portion 206 of the user interface 202. For example, a user utilizing the display of an input device may enter text into the document displayed in the first portion.

The first portion 206 and the second portion 208 of the user interface 202 are configured so that the second portion 208 does not substantially interfere with the display of data in the first portion 206. Although the second portion 208 of the user interface 202 may result in less displayable area on a display device for the first portion 206, the second portion does not substantially cover or obscure the first portion. In this way, a user of the keyboard 210 may enter and manipulate data without having the input device display impede the viewing of the initial display of data.

A user interface of the present invention may be configured in a variety of ways as desired by a user in order to optimize interaction with preferred display formats and display characteristics. For example, as shown in FIG. 2A, a bar 212 is provided to divide the user interface 202 as desired by the user. The bar 212 may be manipulable by the user, such as through a cursor control device, initiated by a menu command, macro, and like methods as contemplated by a person of ordinary skill in the art in order to size the first portion 206 and the second portion 208 of the user interface 202 as desired.

Additionally, the portions may be placed in a variety of arrangements. For example, as shown in the embodiment 250 depicted in FIG. 2B, a user interface including a first portion having a display of data received from a user application and a second portion having a display of an input device arranged in a vertical manner is shown. The user interface 252 includes a display of data 254 received from a word processing application operating on an information handling system. Due to the vertical nature of the display of data 254, the user interface is divided so that the first portion 256 and the second portion 258 including a keyboard 260 are arranged vertically. In this way, the arrangement of the display of data and the available viewing area of a display device are optimized.

Further, a display of an input device may be optimized based on a variety of criteria. For example, the keyboard 210 of FIG. 2A is displayed in a horizontal layout with functional elements taking advantage of the available horizontal arrangement, while the keyboard 260 of FIG. 2B is arranged in a vertical manner, with functional elements arranged vertically, such as by placing a display of a numerical keypad 262 below a display of an alphabetic keypad 264. Although positioning of keypads is described, it should be apparent that a variety of optimizations are contemplated by the present invention without departing from the spirit and scope thereof, such as key size, arrangement of keys, arrangement of portions of-the user interface, and the like as contemplated by a person of ordinary skill in the art.

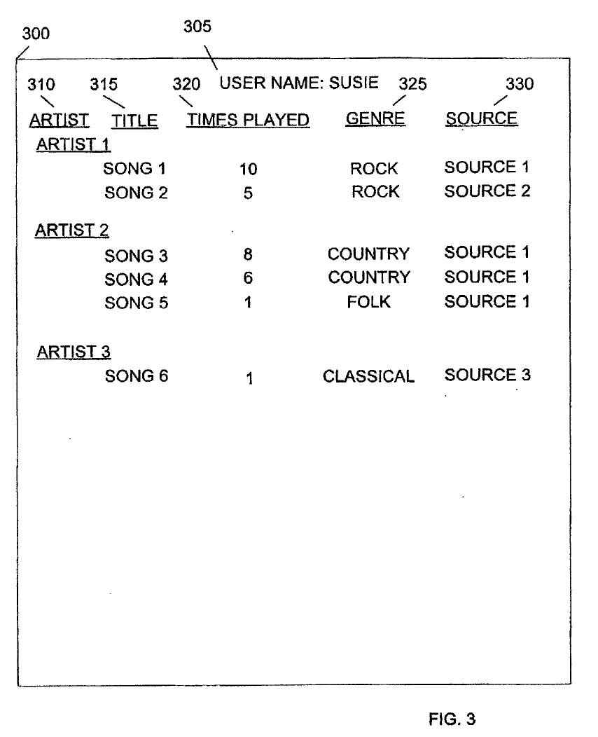

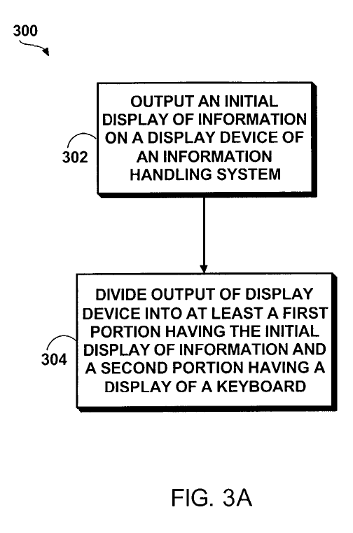

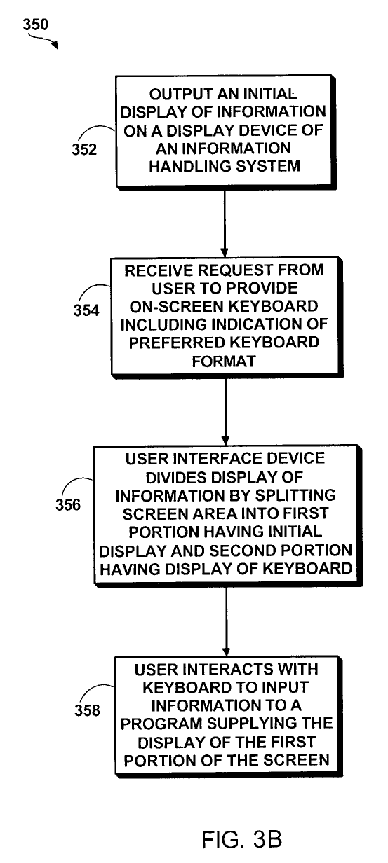

Referring now to FIG. 3A, an exemplary method 300 of the present invention is shown wherein an output of an initial display of information is divided into at least a first portion including the initial display of information and a second portion having a display of an input device. An initial display of information is output on a display device of an information handling system 302. The output of the display device is divided into at least a first portion having the initial display of information and a second portion having a display of an input device 304. The display of the input device may include a variety of alphanumeric devices, such as an alphabetic arrangement of keys, a numeric keypad, a QWERTY keyboard, and the like without departing from the spirit and scope of the present invention.

Preferably, the display of the input device does not interfere with the display of the initial data. For example, the display of the input device may be positioned so that it does not cover elements of the initially output data. This may include determining whether displayed areas contain desirable elements, such as graphical and/or textual elements, as opposed to “open” space, such as a background of a web page.

Referring now to FIG. 3B, an exemplary method 350 of the present invention is shown wherein a request is received from a user to divide a user interface to include a display of an input device which is suitable for providing data to a program of instructions supplying the displayed data. An initial display of information is output on a display device of an information handling system 352. A request is received from a user to provide an on-screen keyboard including an indication of a preferred keyboard format 354.

For instance, a user may drag a bar across a user interface and position the bar as desired to divide the display into a first portion and a second portion 356. The proportions of the display area may be used to format the keyboard, such as a generally horizontal portion, such as shown in FIG. 2A, would have a horizontally oriented keyboard. Likewise, a generally vertical portion, such as shown in FIG. 2B, may have a vertically oriented keyboard. The user may then interact with the keyboard to input information, such as to a program or application supplying information for the display of data in the first portion 358 of the user interface. Thus, a user may interact with data by manipulating the display of the input device from the second portion of the user interface.

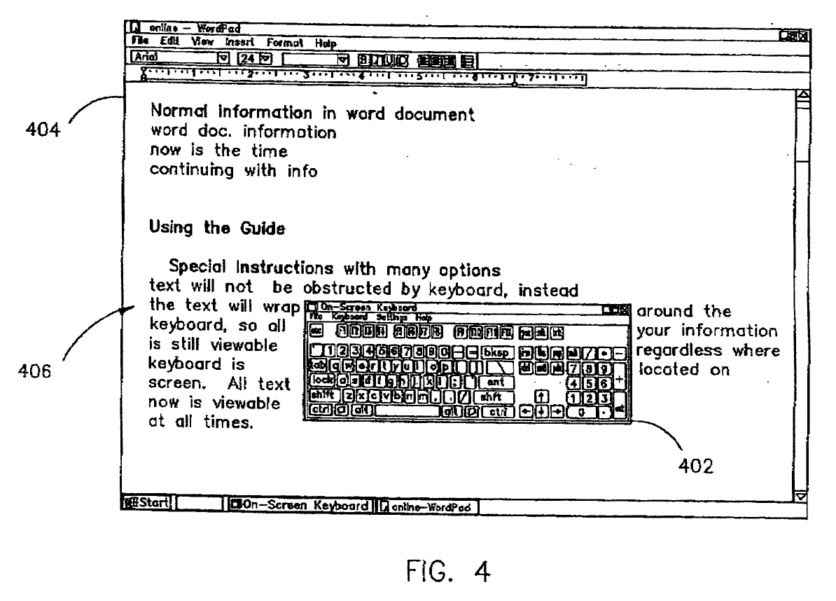

Referring now to FIG. 4, an embodiment 400 of the present invention is shown wherein an initial display of data output by a display device is arranged so that a display of an input device does not interfere with the initially displayed data. In some instances, a user may have a desired position for a display of an input device 402, but still does not want display of the input device 402 to interfere with data output by a program. Therefore, the initial display of data may be configured so that the data is viewable by a user of the information handling system.

For instance, text 406 included in the initial display 404 may be wrapped around a border of the display of the input device 402. Additionally, graphical elements may be repositioned so that the display of the input device does not interfere with viewing of the elements, and the like as contemplated by a person of ordinary skill in the art. Thus, in this instance, a user is able to interact with a display of an input device positioned as desired by the user and still interact with the display of data.

In the previous example, the display of data was configured based on desired placement of a display of an input device. In other instances, it may be desirable to configure the display of the input device based on the initial display of data by a display device, such as to maximize the amount viewable data of the initial display of data.

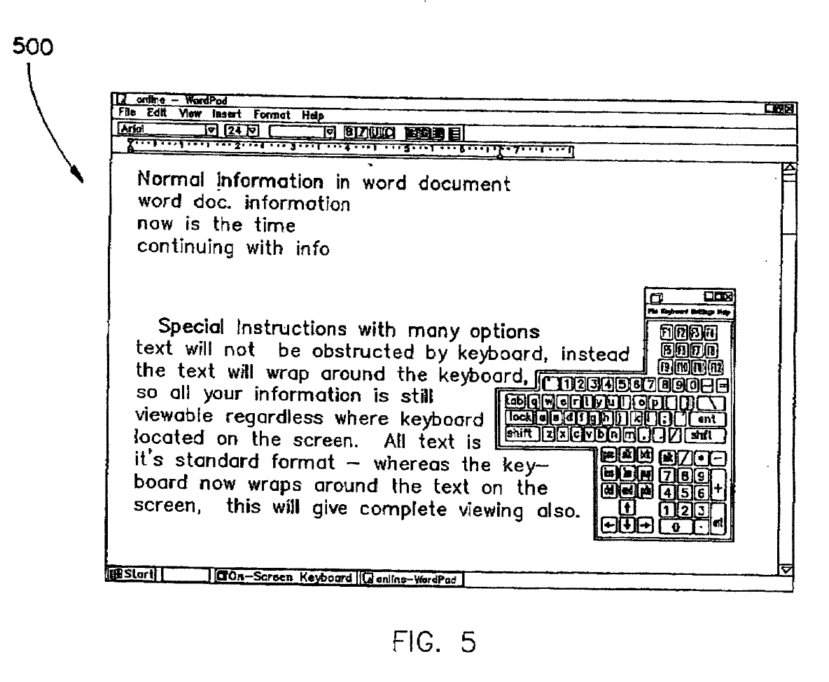

For example, referring now to FIG. 5, an embodiment 500 of the present invention is shown wherein a display of an input device output by a display device is arranged so that it does not interfere with data corresponding to an initial display of data. In this instance, the display of the input device is at least one of positioned and arranged based on the initial display of data. For instance, the use interface may identify open areas of an initial display of data, such as areas which do not contain graphical or textual elements, and configure the input device based on those areas. Configuring the display of the input device may include positioning elements of the device, such as displays of alphanumeric keys, sizing the elements of the device, arranging the elements within the display of the device, which elements are provided such as displaying element most commonly utilized by the user, and the like as contemplated by a person of ordinary skill in the art.

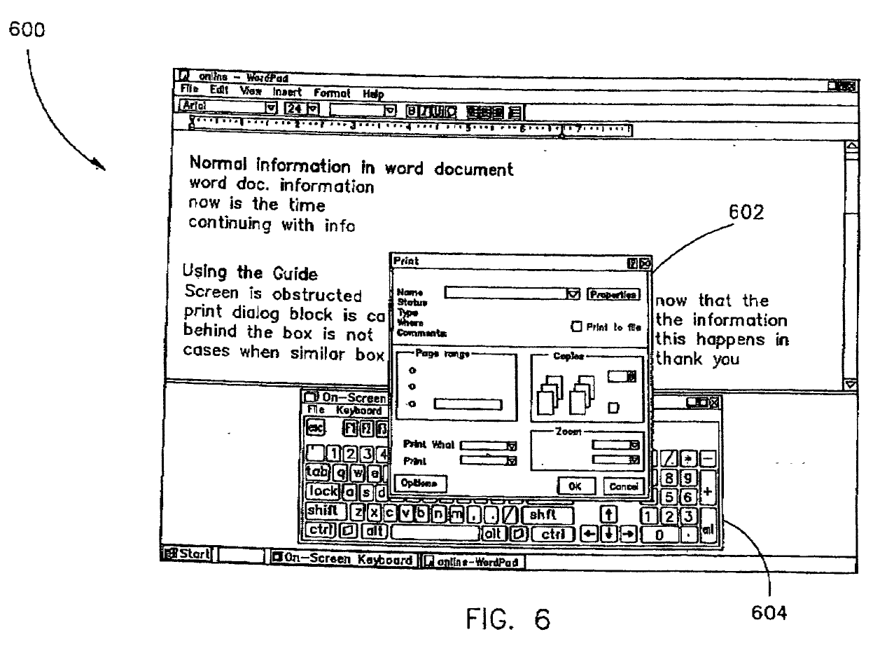

Referring now to FIG. 6, an embodiment 600 of the present invention is shown wherein a priority is assigned to displayable elements to be utilized in determining the presentational aspects of a window. Although the present invention provides for a user interface having a display of an input device which is accessible to a user without interference and/or interfering with other outputs, there may be instances in which a user desires that a window be displayed over the display of the input device.

For example, a window 602 may be displayed which requires user interaction, such as selecting an option. Such user interaction may be required before proceeding with other information handling system activities. Therefore, the window 602 may be given a priority so that the window 602 is displayable over a display of the input device 604. In this way, user movement of a cursor control device may be minimized, thereby resulting in more efficient interaction.

Priority of displayed windows in accordance with the present invention may include a variety of criteria. For instance, a window may be given priority to be displayed in a first portion 606 of a user interface but is not displayed in the second portion 608 of the display device. Other priority criteria may also be utilized, such as based on type of required user interaction; type of window such as pop-up, pop-behind, and the like; size of window; window program source; selectable and/or automatically determined based on monitored past user preferences; and the like as contemplated by a person of ordinary skill in the art. In this way, the provision of windows may be adjusted depending on the desires of a user, such as to limit required user movement, display coverage, and the like.

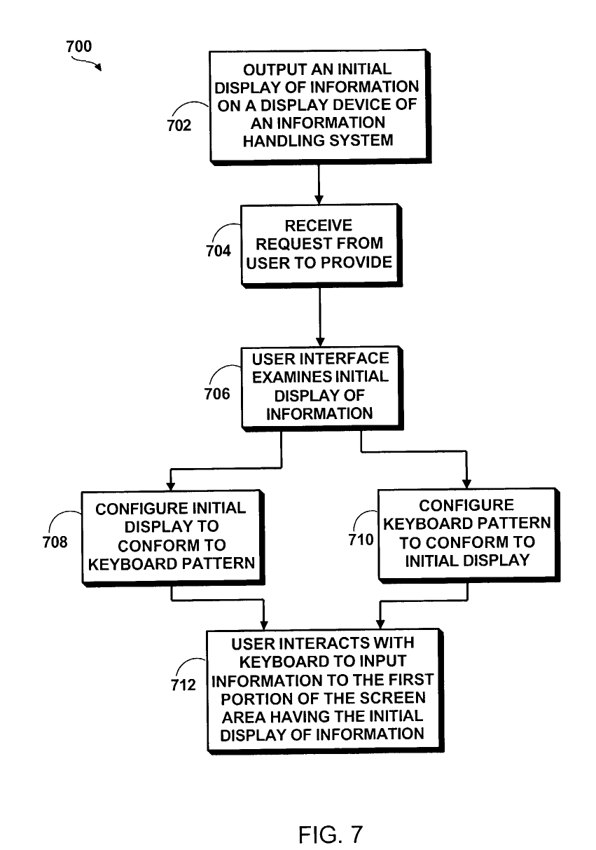

Referring now to FIG. 7, an exemplary method of the present invention is shown wherein a user interface providing a display of an input device is optimized. An initial display of information is output on a display device of an information handling system 702 and a request is received to divide the user interface 704. The user interface, in response to the request, first examines the initial display of information 706. The examination of the display of data is then used to optimize the user interface.

For example, the initial display may be configured to conform to a keyboard pattern 708, such as shown in FIG. 4. Additionally, a keyboard pattern may be configured to conform to the examined initial display of information 710, such as shown in relation to FIG. 5. The user may then interact with the optimized keyboard to input information to the first portion of the screen area having the initial display of information 712. Although a keyboard has been described, it should be apparent that a display of a data input device may be configured in a variety of formats without departing from the spirit and scope of the present invention.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A dividable user-interface displayable by a display device of an information handling system, comprising:
a user interface divided from an initial display of information output by a display device of an information handling system, the divided user interface including at least a first portion having data corresponding to the initial display of information and a second portion having a display of an input device, the input device suitable for providing data entered by a user through the input device to the information handling system;
wherein the display of the input device displayed in the second portion of the user interface does not substantially interfere with data corresponding to the initial display of information as displayed in the first portion of the user interface.

2. The user-interface as described in claim 1, wherein the display of the input device displayed in the second portion of the user interface is suitable for inputting data to a program providing information for the data corresponding to the initial display of information as output in the first portion of the user interface, the data including at least one of alphabetic and numeric data.

3. The user-interface as described in claim 1, wherein the first portion having data corresponding to the initial display of information is configured to conform to the displayed input device.

4. The user-interface as described in claim 1, further comprising examining the initial display of information and dividing the user interface into at the first portion and the second portion based on the examination.

5. The user-interface as described in claim 4, wherein dividing the user interface includes configuring the display of the input device to conform to the initial display of information.

6. The user-interface as described in claim 5, wherein conforming includes displaying items of the input device display in areas of the initial display of data which do not have at least one of a textual and graphical element.

7. The user-interface as described in claim 1, further comprising receiving a request to divide the user interface so as to include a display of an input device, wherein the request is received through at least one of dragging a display of a bar across the screen, entering a command, entering a macro and entering a command from a menu.

8. The user-interface as described in claim 1, wherein interference of the first portion of the user interface by the second portion of the user interface includes covering the first portion so that a sizeable segment of data corresponding to the initial display of data is not viewable by a user viewing the display device.

9. The user-interface as described in claim 1, wherein the display of the input device includes at least one of an alphabetic input elements, numerical input elements, a QWERTY keyboard and a numerical keypad.

10. A method of providing a dividable user-interface which is displayable by a display device of an information handling system, comprising:
outputting a user interface having an initial display of information by a display device of an information handling system; and
dividing the user interface into at least a first portion having data corresponding to the initial display of information and a second portion having a display of an input device, the input device suitable for providing data entered by a user through the input device to the information handling system;
wherein the display of the input device displayed in the second portion of the user interface does not substantially interfere with data corresponding to the initial display of information as displayed in the first portion of the user interface.

11. The method as described in claim 10, wherein the display of the input device displayed in the second portion of the user interface is suitable for inputting data to a program providing information for the data corresponding to the initial display of information as output in the first portion of the user interface, the data including at least one of alphabetic and numeric data.

12. The method as described in claim 10, wherein the first portion having data corresponding to the initial display of information is configured to conform to the displayed input device.

13. The method as described in claim 10, further comprising examining the initial display of information and dividing the user interface into at the first portion and the second portion based on the examination.

14. The method as described in claim 13, wherein dividing the user interface includes configuring the display of the input device to conform to the initial display of information.

15. The method as described in claim 14, wherein conforming includes displaying items of the input device display in areas of the initial display of data which do not have at least one of a textual and graphical element.

16. The method as described in claim 10, further comprising receiving a request to divide the user interface so as to include a display of an input device, wherein the request is received through at least one of dragging a display of a bar across the screen, entering a command, entering a macro and entering a command from a menu.

17. The method as described in claim 10, wherein interference of the first portion of the user interface by the second portion of the user interface includes covering the first portion so that a sizeable segment of data corresponding to the initial display of data is not viewable by a user viewing the display device.

18. The method as described in claim 10, wherein the display of the input device includes at least one of an alphabetic input elements, numerical input elements, a QWERTY keyboard and a numerical keypad.

19. An information handling system including a dividable user-interface, comprising:
a memory suitable for storing a program of instructions;
a display device suitable for providing a display of data; and
a processor suitable for performing a program of instructions, the processor communicatively coupled to the display device and the memory, wherein the program of instructions configures the processor to output a user interface having an initial display of information by the display device; and
divide the user interface into at least a first portion having data corresponding to the initial display of information and a second portion having a display of an input device;
wherein the display of the input device displayed in the second portion of the user interface does not substantially interfere with data corresponding to the initial display of information as displayed in the first portion of the user interface.

20. The information handling system as described in claim 19, wherein the first portion having data corresponding to the initial display of information is configured to conform to the displayed input device.

21. The information handling system as described in claim 19, further comprising examining the initial display of information and dividing the user interface into at the first portion and the second portion based on the examination.

22. The information handling system as described in claim 21, wherein dividing the user interface includes configuring the display of the input device to conform to the initial display of information.

23. The information handling system as described in claim 22, wherein conforming includes displaying items of the input device display in areas of the initial display of data which do not have at least one of a textual and graphical element.

24. A dividable user-interface displayable by a display device of an information handling system, comprising:
means for outputting a user interface having an initial display of information by a display device of an information handling system; and
means for dividing the user interface into at least a first portion having data corresponding to the initial display of information and a second portion having a display of means for inputting data, the input means suitable for providing data entered by a user through the input means to the information handling system;
wherein the display of the input means displayed in the second portion of the user interface does not substantially interfere with data corresponding to the initial display of information as displayed in the first portion of the user interface.
